(19) United States
(12) Patent Application Publication
(10) Pub. No.: US 2012/0126003 A1
(43) Pub. Date: May 24, 2012

(54) INTELLIGENT CORRELATED SCANNING OPERATION FOR MOBILE CODE ENABLER

(75) Inventor: Shu Wang, Richardson, TX (US)

(73) Assignee: SAMSUNG ELECTRONICS CO. LTD., Suwon-si (KR)

(21) Appl. No.: 12/954,018

(22) Filed: Nov. 24, 2010

(51) Int. Cl. G06K 7/00

(52) U.S. Cl. 235/435

(57) ABSTRACT

An apparatus and method for an intelligent correlated scanning are provided. The method includes receiving, by a server, a first identifier of a scanned Mobile Code (MC) from a mobile station, determining, by the server, a second identifier of an MC correlated with the scanned MC based on the first identifier, and resolving, by the server, the first and second identifiers. The intelligent correlated scanning operation automatically identifies MCs that are correlated with the scanned MC such that the user's scanning experience is improved.

### BACKGROUND OF THE INVENTION

1. Field of the Invention

The present invention relates to an apparatus and method for scanning a Mobile Code (MC). More particularly, the present invention relates to an apparatus and method for correlating MCs and providing an intelligent operation based on the correlated MCs.

2. Description of the Related Art

Mobile stations were originally developed to provide simple wireless communication between users. As technology has advanced, mobile stations now provide many additional and advanced features beyond the simple telephone conversation. For example, mobile stations now allow a user to send and receive Electronic mail (Email), receive a multicast or broadcast service, receive a Global Positioning System (GPS) signal to determine the mobile station's location, receive an Internet service, and the like. Furthermore, mobile stations are provided with components that enhance the usability of the device. For example, a mobile station may be provided with a high quality speaker for use in making conference calls and listening to music files, an advanced display for reproducing high definition video signals and for functioning as a touch screen to receive user input, a high resolution camera to capture still and moving images, and the like.

One advanced feature provided for mobile stations is the ability to scan, decode, and execute a Mobile Code (MC). An MC may be a 1-Dimensional (1D) barcode, such as a Universal Product Code (UPC), or a 2-dimensional (2D) barcode, such as a data matrix or a Quick Response (QR) code. Furthermore, an MC may provide information either directly or indirectly. That is, an MC may be encoded with specific content or a Uniform Resource Locator (URL) containing an address of a corresponding service so as to provide the information directly, or may indirectly provide information by connecting to a server corresponding to the scanned MC. An advantage of using an MC is that information, such as an application download or other mobile-specific pages, is obtained much quicker as compared to retrieving the information by typing a corresponding request into the mobile station.

As technology advances and mobile stations are able to execute advanced features, such as the ability to scan, decode, and execute an MC, service carriers are responding by researching, developing, and providing corresponding services. However, when many service carriers develop such services, there is a potential that only users subscribing to the same service carrier will be able to exchange information or communicate with each other using the advanced components and features. To alleviate this concern, the Open Mobile Alliance (OMA) was formed to ensure that, regardless of the type of device, service or carrier that a mobile station is using, the mobile station will be able to communicate and exchange information with other mobile stations. To this end, members of the OMA develop open, market driven interoperable specifications for global adoption of data services. Once a technology or specification is developed, the OMA issues a service enabler, which is a management object designated for the particular specification or purpose, for use by a mobile station. For example, the OMA has issued several service enablers for technologies and purposes such as Email notification, browsing, mobile advertising, and secure content exchange.

Regarding the development and use of MCs, one concern is that different service providers may create and advance specific types of symbols or data formats that would only interact with their systems. In response, the OMA formed a working group to address these concerns and has issued a candidate MC enabler to address these potential problems. More specifically, the candidate MC enabler includes standards regarding the requirements and architecture of all components of an MC system.

However, the OMA MC enabler currently considers the scanning, decoding, and use of an MC as a unitary or one-time activity. That is, the OMA candidate MC enabler only addresses a scenario in which a user scans and receives information regarding a single MC. Although this simplifies the resolution process, it does not adequately address situations in which a series of correlated MCs need to be scanned. Accordingly, there is a need for an improved apparatus and method for providing a correlated MC set and for providing an intelligent correlated scanning operation.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for establishing a correlated Mobile Code (MC) set.

Yet another aspect of the present invention is to provide an apparatus and method for an intelligent correlated MC scanning operation.

In accordance with an aspect of the present invention, a method for controlling information corresponding to an MC by a server is provided. The method includes receiving a first identifier of a scanned MC from a mobile station, determining a second identifier of an MC correlated with the scanned MC based on the first identifier, and resolving the first and second identifiers.

In accordance with another aspect of the present invention, an apparatus for controlling information corresponding to an MC by a server is provided. The apparatus includes a receiver for receiving a first identifier of a scanned MC from a mobile station, and a controller for determining a second identifier of an MC correlated with the scanned MC based on the first identifier, and for resolving the first and second identifiers.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1A is a block diagram illustrating a system for providing an MC service according to an exemplary embodiment of the present invention;

FIG. 1B is a block diagram illustrating an MC client and server according to an exemplary embodiment of the present invention; and

FIG. 2 is a flow diagram of an intelligent correlated scanning operation according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The following exemplary embodiments of the present invention are described as applied to a “mobile station.” However, it is to be understood that this is merely a generic term and that the invention is equally applicable to any of a mobile phone, a palm sized Personal Computer (PC), a Personal Digital Assistant (PDA), a Hand-held PC (HPC), a smart phone, an International Mobile Telecommunication 2000 (IMT-2000) terminal, a wireless Local Area Network (LAN) terminal, and the like. Accordingly, use of the term “mobile station” should not be used to limit application of the present inventive concepts to any certain type of apparatus or device.

The current Mobile Code (MC) enabler and system as established by the Open Mobile Alliance (OMA) are able to provide a user with access to information simply by scanning an MC. However, the current MC enabler and system have certain drawbacks. For example, the current OMA MC enabler treats an MC scanning event as a single or solitary event. Though this simplifies the MC resolution process, it may result in an inconvenience to the user. That is, the MC scanning process needs to address a situation in which a series of correlated MC scanning events may be required.

As an example, there may occur a situation in which, while reading a daily newspaper, a user finds a holiday promotion in which she has interest. To participate in the promotion, the user scans an MC, which is printed in the newspaper and associated with the promotion, with her mobile phone. As a result of the scan, she receives a response that explains that she has scanned the second day of a three day promotion and that she needs scan all three days to complete her entry. The response also indicates that she can enter for the previous day on a related website. However, the user may not have access to the Internet or may not know how to use a computer. In either case, the user cannot participate in the promotion as she would like.

As illustrated above, the lack of an intelligent correlated scanning operation causes a significant inconvenience for the user. Moreover, because existing MC enabler models do not account for this limitation, it may eventually prevent the wide use MCs.

Accordingly, exemplary embodiments of the present invention provide an intelligent correlated scanning operation for an MC enabler. As will be described in more detail below, an exemplary intelligent correlated scanning operation provides an improved user experience such as the ability to find missed MCs that are correlated with a scanned MC, to pre-schedule an MC scanning based on a correlated MC, and the like. That is, an intelligent correlated scanning operation allows a user to identify information associated with other MCs merely by scanning a single MC.

In the following description, the term “correlated MC set” denotes a series or set of correlated MCs that may be associated for use in MC scanning. In other words, while a typical MC scanning operation considers a single MC, an MC scanning operation using a correlated MC set according to an exemplary embodiment of the present invention considers a series of correlated MCs. The term “intelligent correlated scanning operation” denotes an operation in which, when a user scans an MC included in a correlated MC set, an MC server is able to automatically identify other correlated MCs and return the correlated decoded results to the user.

Exemplary embodiments of the present invention as described below include an apparatus and method for providing an MC enabler that includes a set of correlated MCs and for providing an intelligent correlated scanning operation using correlated MCs.

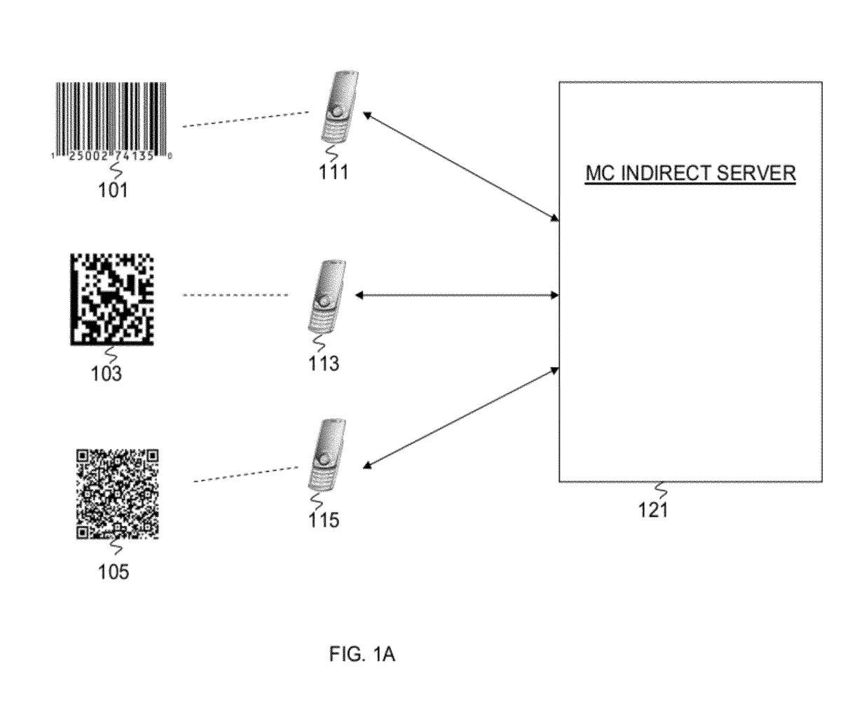

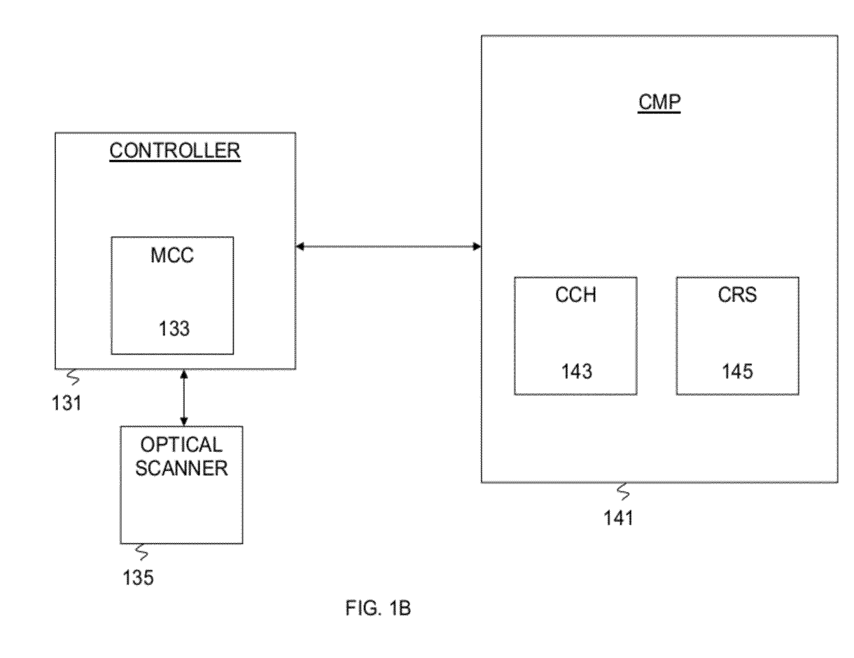

FIG. 1A is a block diagram illustrating a system for providing an MC service according to an exemplary embodiment of the present invention.

Referring to FIG. 1A, the architecture of an MC system is established using a client-server relationship. Thus, as an example, a first Mobile Station (MS) 111, a second MS 113 and a third MS 115 are provided as clients, and an Indirect MC Server 121 is provided as a server. In the example of FIG. 1A, any of the first MS 111, the second MS 113, and the third MS 115 may scan and decode an MC. As an example, it is assumed that the first MS 111 scans a first MC 101. In this case, the first MC 101 includes a Universal Product Code (UPC), which is a 1-Dimensional (1D) MC. Further, it is assumed that the second MS 113 scans a second MC 103, and the third MS 115 scans a third MC 105. In this case, both the second MC 103 and the third MC 105 include 2-Dimensional MCs. More specifically, the second MC 103 is a data matrix, and the third MC 105 is a Quick Reference (QR) code.

When any of the first through third MSs 111-115 scans an MC, the MS that scanned the MC decodes the scanned MC and transmits the decoded data to the Indirect MC Server 121. Upon receipt of the decoded data from the MS, the Indirect MC Server 121 resolves the data, retrieves information associated with the resolved data, and provides the retrieved information to the MS. Furthermore, according to an exemplary embodiment of the present invention, when the Indirect MC Server 121 resolves the received data, the resolution may include an intelligent correlated operation based on a correlated set of MCs. That is, the Indirect MC Server 121 may resolve not only the information associated with the scanned MC, but may also resolve information associated with one or more MCs that are correlated with the scanned MC. A more detailed explanation of the components of the MS and the Indirect MC Server 121 as well as their respective functions is provided below with reference to FIG. 1B.

FIG. 1B is a block diagram illustrating an MC client and server according to an exemplary embodiment of the present invention.

Referring to FIG. 1B, the MC client of the client-server relationship is implemented using an MS that includes a controller 131 and an optical scanner 135. The controller 131 is provided to control general operations of the MS. For example, the controller 131 processes and controls voice communication and data communication functions of the MS through one or more communication units (not shown), as well as other functions such as controlling a storage unit (not shown), a display unit (not shown), and the like. The controller 131 also includes a Mobile Code Client (MCC) 133 that may be provided as an MC enabler software entity or as a separate component that resides in the MS. The MCC 133 functions to decode and extract information from a scanned MC, determine an Indirect Code Identifier (ICI) based on the decoded information, provide the decoded data including the ICI associated with the scanned MC to a server, receive content information associated with the scanned MC from the server, and provide the content information to a user. The MCC 133 may be referred to as a “Mobile Code Reader.”

The optical scanner 135 is provided for visually scanning an MC and may be implemented as a camera using, for example, a Charge Coupled Device (CCD) image sensor, a Complementary Metal Oxide Semiconductor (CMOS) image sensor, and the like. Of course, it is to be understood that additional components may also be included in the MS but are not illustrated in FIG. 1B included here for sake of convenience. For example, the MS may further include components such as an input unit, a display unit, a storage unit, and the like.

In operation, the optical scanner 135 scans an MC and provides the results to the MCC 133. The MCC 133 functions to extract information from the scanned MC for transmission to a resolving server. More specifically, upon receiving the scanned results, the MCC 133 decodes and extracts information from the scanned MC, determines an ICI based on the encoded information, and provides the decoded data including the ICI associated with the scanned MC to the controller 131 for transmission to a server.

As illustrated in FIG. 1B, the server of the client-server relationship is implemented with a Code Management Platform (CMP) 141 that includes a Code Clearing House (CCH) 143 and a Code Resolution Server (CRS) 145. Generally, the CMP 141 performs a service of resolving the received MC data from the MS and providing the resolved data to the MS. As illustrated in FIG. 1B, the single CMP 141 typically performs the functions of both the CCH 143 and the CRS 145, such as in a situation in which both functions are operated by the same entity. However, in other situations in which multiple parties are involved, such as in a situation in which a first party provides the function of the CCH 143 and a second party provides the function of the CRS 145, a split CMP scenario may be employed. However, for conciseness, a system employing a single CMP 141 will be explained. Moreover, a CMP that is to resolve the received MC data will be referred to as a “resolving CMP.”

Decoded MC data, that includes an ICI corresponding to the scanned MC, is received from an MS and provided to the CCH 143. Based on the ICI, the CCH 143 determines a resolving CMP and routes the received data to the determined CMP for resolution. In the example of FIG. 1B, because the CCH 143 and CRS 145 are provided by the same CMP 141, the CCH 143 provides the data to the CRS 145 for resolution.

The CRS 145 receives the data including the ICI from the CCH 143 and resolves the data. More specifically, based on the data including the ICI received from the CCH 143, the CRS 145 maps content to be consumed directly by a user or maps an address associated with content or a service for access by the user to the data. After determination of the associated content or determination of an applicable address, the CRS 145 provides the information to the CCH 143 which in turn provides the information to the user of the MS through the controller 131 and the MCC 133.

Moreover, according to an exemplary embodiment of the present invention, the CRS 145 provides an intelligent correlated scanning operation based on the received data. More specifically, the CRS 145 performs an intelligent correlated operation based on the received data that includes determining identifiers (i.e., ICIs) of MCs that are correlated with the scanned MC, resolving the correlated identifiers, and returning the resolved information. By performing the intelligent correlated operation, the CRS 145 is able to automatically identify MCs that are correlated to the scanned MC and, as requested, return the correlated decoded results to the user. Thus, the user is able to obtain information associated with an MC that has not been scanned but that is correlated to an MC that was scanned, which improves the user's experience.

Although not illustrated in FIG. 1B, it is to be understood that the MS includes many additional components such as a display unit, an input unit, a storage unit, and the like which are not illustrated here for sake of convenience. Moreover, while the CMP 141 is illustrated in FIG. 1B as providing the functions of both the CCH 143 and the CRS 145, it is to be understood that these functions may be provided by other entities and that the configuration is not limited to that illustrated. For example, two CMPs may be provided wherein each CMP provides the functions of a CCH and a CRS. In such a case, an MS may transmit decoded data to a first or home CMP which in turn may transmit the data to a second or remote CMP for resolution. In another example, two CMPs may be provided in which a first CMP provides only a CCH function and a second CMP provides only a CRS function. Finally, the system may further include a Mobile Code Registry (MCR) for allocating MC routing prefixes and supporting a data look-up function. Thus, it is to be understood that, although not illustrated, there are many variations to the MC system illustrated in FIG. 1B.

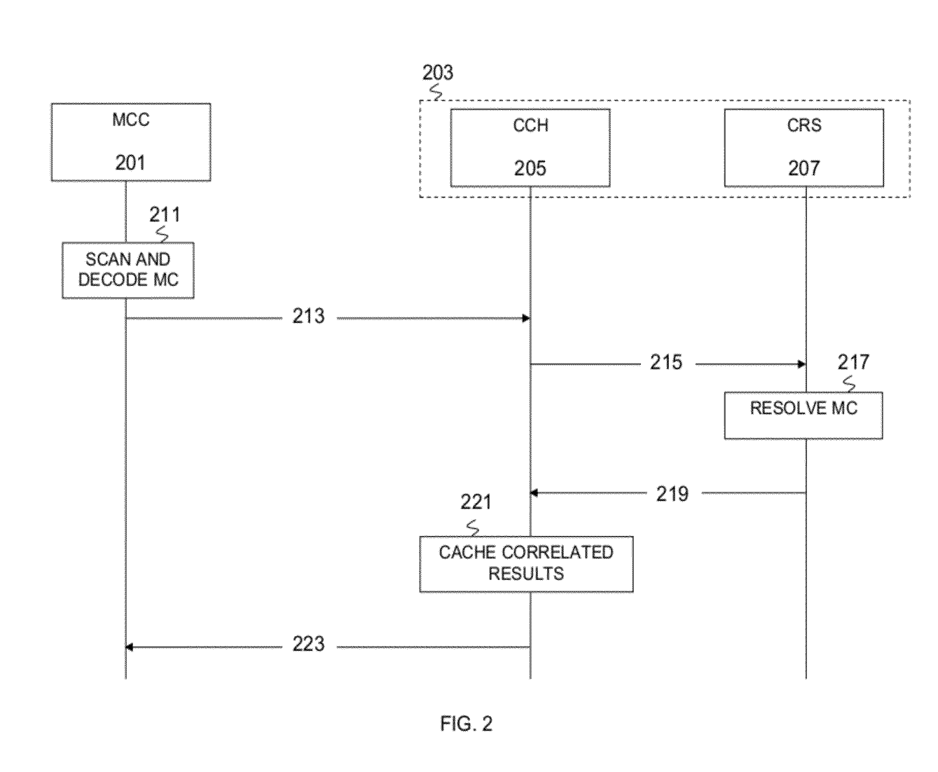

FIG. 2 is a flow diagram of an intelligent correlated scanning operation according to an exemplary embodiment of the present invention.

Referring to FIG. 2, an MCC 201 and a CMP 203 are provided in an MC scanning system. As described above, the MCC 201 may be provided as an MC enabler located at an MS and the CMP 203 is a server that is located remotely from the MS. As also illustrated in FIG. 2, the CMP 203 includes a CCH 205 and a CRS 207. However, the CMP 203 is shown having a dashed outline because the CCH 205 and the CRS 207 may be provided by different CMPs.

In step 211, the MCC 201 scans and decodes an indirect MC that is part of a correlated MC set and determines an identifier (i.e., ICI) associated with the indirect MC. In step 213, the MCC 201 transmits decoded information including the ICI to the CMP 203 for resolution. More specifically, the MCC 201 transmits the ICI to the CCH 205 which uses the ICI to determine a resolving CMP and forwards the ICI to the resolving CMP. In the example of FIG. 2, the CCH 205 determines that the resolving CMP is CMP 203. That is, because the CCH 205 and CRS 207 are provided by the same CMP 203, the CCH 205 forwards the ICI to the CRS 207 for resolution in step 215.

In step 217, the CRS 207 resolves the scanned information including the ICI. To resolve the ICI, the CRS 207 either determines content associated with the ICI or determines an address of content (or a service) associated with the ICI. Moreover, according to an exemplary embodiment of the present invention, the CRS 207 performs an intelligent correlated operation. That is, using the ICI of the scanned MC, the CRS 207 identifies ICIs of MCs correlated with the scanned MC, and resolves the correlated ICIs by determining content associated with the correlated ICIs.

In step 219, the CRS 207 returns the resolution results associated with the ICI of the scanned MC along with the resolution results of the correlated ICIs to the CCH 205. In step 221, the CCH 205 caches the correlated results. Finally, in step 223, the CCH 205 returns the resolution results to the MCC 201. The process of returning the resolution results to the MCC 201 may be performed by returning all results at once, by returning the results of the scanned MC and inquiring if the user desires to view correlated results, returning each correlated result separately, and the like, depending either on a user's input, system requirements, and the like.

According to exemplary embodiments of the present invention, an MC intelligent scanning operation is provided as a correlated operation as opposed to a unitary operation such that the MC scanning process may evolve. That is, the correlated MC scanning operation provides an enhanced experience for users based on its advantages such as avoiding missed scans and pre-scheduling future scans. For example, in the case discussed above regarding the user who had missed the first day of a three-day promotion, by correlating the MCs associated with each day of the promotion, the user is able to request the previous days' information from the MC server because it is correlated with the scanned MC. That is, upon scanning the MC associated with day two of the promotion, the response received by the user not only provides content associated with the scanned MC, but may also inquire whether the user desires the information associated with yesterday's MC that is correlated to the scanned MC. In that case, the user may request an intelligent correlated scanning operation such that information associated with yesterday's MC is also provided. As an alternative, the information associated with the previous days' MC may be automatically provided to the user. In either case, the user is able to obtain information for both days because the MCs are correlated.

Furthermore, since the promotion is a three day event and it is only the second day, the user may request the MC server to pre-schedule an auto-scan for the next or any subsequent day. In that case, the MC server receives the scheduling request, pre-schedules the request, automatically identifies the requested code based on the correlated MC, and provides the results to the user on the scheduled day. In that case, the user's time is saved by avoiding the necessity of waiting for the paper and scanning the MC such that the user's MC scanning experience is enhanced. Furthermore, the entity providing the correlated MCs is not only able to monetize the first scan, but also the correlated scans, thus providing yet another advantage.

At this point it should be noted that the exemplary embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the exemplary embodiments of the present invention as described above. Alternatively, one or more processors operating in accordance with stored instructions may implement the functions associated with the exemplary embodiments of the present invention as described above. If such is the case, it is within the scope of the present disclosure that such instructions may be stored on one or more processor readable mediums. Examples of the processor readable mediums include Read-Only Memory (ROM), Random-Access Memory (RAM), CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present invention can be easily construed by programmers skilled in the art to which the present invention pertains.

While the invention has been shown and described with reference to certain exemplary embodiments thereof, it will be understood by those skilled in the art that various changes in form and details may be made therein without departing from the spirit and scope of the invention as defined by the appended claims and their equivalents.

1. A method for controlling information corresponding to a Mobile Code (MC) by a server, the method comprising:
receiving, from a mobile station, an identifier of a first MC scanned by the mobile station;
determining an identifier of second MC, correlated with the first MC, based on the identifier of the first MC; and
resolving the identifiers of the first MC and the second MC.

2. The method of claim 1, wherein the resolving of the identifiers of the first MC and the second MC comprises acquiring content respectively associated with the identifier of the first MC and the identifier of the second MC or acquiring an address of content or a service respectively associated with the identifier of the first MC and the identifier of the second MC.

3. The method of claim 1, further comprising transmitting the resolved identifiers of the first MC and the second MC to the mobile station.

4. The method of claim 3, wherein the transmitting of the resolved identifiers of the first MC and the second MC to the mobile station comprises:
transmitting the resolved identifier of the first MC to the mobile station; and
transmitting the resolved identifier of the second MC to the mobile station upon receiving a request for transmission of the resolved identifier of the second MC from the mobile station.

5. The method of claim 1, wherein the identifier of the first MC comprises an Indirect Code Identifier (ICI) associated with the first MC scanned by the mobile station and the identifier of the second MC comprises an ICI associated with the second MC correlated with the first MC.

6. The method of claim 1, wherein the resolving of the identifiers of the first MC and the second MC comprises:
resolving the identifier of the first MC at a first time; and
resolving the identifier of the second MC at a second time that is later than the first time.

7. The method of claim 6, wherein the second time is determined based on an instruction received from the MS.

8. A method for receiving information corresponding to a Mobile Code (MC) by a mobile station, the method comprising:
scanning an MC by the mobile station;
transmitting an identifier of the scanned MC to a server; and
receiving information corresponding to the scanned MC and information corresponding to an MC correlated with the scanned MC.

9. The method of claim 8, wherein the receiving of the information corresponding to the scanned MC and the information corresponding to an MC correlated with the scanned MC comprises:
receiving the information corresponding to the scanned MC;
transmitting a request to receive the information corresponding to the MC correlated with the scanned MC; and
receiving the information corresponding to the MC correlated with the scanned MC.

10. The method of claim 8, further comprising transmitting a request to the server to resolve information corresponding to the MC correlated with the scanned MC at a later time.

11. An apparatus for controlling information corresponding to a Mobile Code (MC) by a server, the apparatus comprising:
a receiver for receiving an identifier of a first MC, scanned by a mobile station, from the mobile station; and
a controller for determining an identifier of a second MC correlated with the first MC based on the identifier of the first MC and for resolving the identifiers of the first MC and the second MC.

12. The apparatus of claim 11, wherein the controller resolves the identifiers of the first MC and the second MC by acquiring content respectively associated with the identifier of the first MC and the identifier of the second MC or acquiring an address of content or a service respectively associated with the identifier of the first MC and the identifier of the second MC.

13. The apparatus of claim 11, further comprising a transmitter for transmitting the resolved identifiers of the first MC and the second MC to the mobile station.

14. The apparatus of claim 13, wherein the transmitter transmits the resolved identifiers of the first MC and the second MC to the mobile station by transmitting the resolved identifier of the first MC to the mobile station and transmitting the resolved second identifier of the second MC to the mobile station upon receiving a request for transmission of the resolved identifier of the second MC from the mobile station.

15. The apparatus of claim 11, wherein the identifier of the first MC comprises an Indirect Code Identifier (ICI) associated with the first MC scanned by the mobile station and the identifier of the second MC comprises an ICI associated with the second MC correlated with the first MC.

16. The apparatus of claim 11, wherein the controller resolves the identifiers of the first MC and the second MC by resolving the identifier of the first MC at a first time and resolving the identifier of the second MC at a second time that is later than the first time.

17. The apparatus of claim 16, wherein the second time is determined based on an instruction received from the MS.

18. An apparatus for receiving information corresponding to a Mobile Code (MC) by a mobile station, the apparatus comprising:
an optical scanner for scanning an MC by the mobile station;
a transmitter for transmitting an identifier of the scanned MC to a server; and
a receiver for receiving information corresponding to the scanned MC and information corresponding to an MC correlated with the scanned MC.

19. The apparatus of claim 18, wherein the receiver receives the information corresponding to the scanned MC and the information corresponding to an MC correlated with the scanned MC by receiving the information corresponding to the scanned MC, transmitting a request to receive the information corresponding to the MC correlated with the scanned MC, and receiving the information corresponding to the MC correlated with the scanned MC.

20. The apparatus of claim 18, wherein the transmitter transmits a request to the server to resolve information corresponding to the MC correlated with the scanned MC at a later time.
